(19) United States
(12) Patent Application Publication
(10) Pub. No.: US 2009/0075138 A1
(43) Pub. Date: Mar. 19, 2009

(54) Electrochemical Device And Process For Manufacturing An Electrochemical Device

(76) Inventors: Agustin Sin Xicola, Milano (IT); Antonino Salvatore Arico, Messina (IT); Daniela La Rosa, Messina (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/224,990

(22) PCT Filed: Mar. 14, 2006
(86) PCT No.: PCT/EP2006/002340

§ 371 Date: Sep. 30, 2008

(51) Int. Cl. H01M 4/02

(52) U.S. Cl. 429/29; 264/104

(57) ABSTRACT

An electrochemical device includes at least one porous supporting electrode including at least one electronically conducting material and at least one ionically conducting material, said ionically conducting material having an ionic conductivity, at 800° C., not lower than or equal to 0.005 S/cm⁻¹, preferably 0.01 S/cm⁻¹ to 0.1 S/cm⁻¹, said at least one porous supporting electrode having a thickness greater than or equal to 200 μm, preferably 500 μm to 2 mm; at least one electrolyte membrane having a relative density greater than or equal to 90%, preferably 95% to 100%, and a thickness lower than or equal to 50 μm, preferably 5 μm to 30 μm; and at least one porous counter-electrode.

The present invention relates to an electrochemical device and to a process for manufacturing an electrochemical device.

In particular, the present invention relates to an electrochemical device, more in particular to a solid state electrochemical device, comprising at least one porous supporting electrode, at least one thin electrolyte membrane having a high relative density, and at least one porous counter-electrode.

Furthermore, the present invention also relates to a process for manufacturing an electrochemical device.

Solid state electrochemical devices are often implemented as cells including two porous electrodes, the anode and the cathode, and a dense solid electrolyte membrane which separate the electrodes.

In many implementations such as, for example, in fuel cells and oxygen and syn gas generators, the solid electrolyte membrane comprises a material capable of conducting ionic species such as, for example, oxygen ions, or hydrogen ions, said material having a very low, or even absent, electronic conductivity. In other implementations such as, for example, gas separation devices, the solid electrolyte membrane comprises a mixed ionic electronic conducting material (“MIEC”) . In each case, the solid electrolite membrane must be dense and pinhole free (“gas-tight”) to prevent mixing of the electrochemical reactants.

Solid state electrochemical devices are becoming increasingly important for a variety of applications including energy generation, oxygen separation, hydrogen separation, coal gasification, selective oxidation of hydrocarbons. These devices are typically based on electrochemical cells with ceramic electrodes and electrolyte membranes and have two basic design: tubular and planar. Usually, said electrochemical devices operate at high temperatures, tipically in excess of 900° C. However, such high temperature operation has significant drawbacks with regard to the devices maintainance and the materials available for incorporation into a device, in particular, in the oxidizing environment of an oxygen electrode, for example.

Some recent attempts have been made to develop solid state electrochemical devices which efficiently operate at lower temperature.

For example, U.S. Pat. No. 6,921,557 relates to a process for making a composite article comprising:
a) providing a porous substrate;
b) applying a metal oxide and/or mixed metal oxide, and a metal or metal alloy to porous substrate;
c) heating the porous substrate and metal or metal alloy in a reducing atmosphere at a temperature of between about 600° C. and about 1500° C.;
d) switching the atmosphere from a reducing atmosphere to an oxidizing atmosphere during the sintering of the layer;
e) thus producing a coating on a porous substrate.

Suitable material for said porous substrate are cermets (ceramic and metallic composite materials) such as, for example, lantanium strontium manganese oxide (LSM) incorporating one or more transition metals such as, for example, chromium, iron, copper and silver, or alloys thereof); metals (such as, for example, chromium, silver, copper, iron, nickel); or metal alloys (such as, for example, low-chromium ferritic steel, high-chromium ferritic steel, chrome-containing nickel-based Inconel alloys including Inconel 600). Suitable material for said coating is yttria stabilized zirconia (YSZ). The abovementioned composite article may be incorporated in solid state electrochemical devices. Said solid state electrochemical devices are said to work in a wide range of operating temperatures, in particular of from about 400° C. to about 1000° C.

U.S. Pat. No. 6,605,316 relates to a method of forming a ceramic coating on a solid state electrochemical device substrate, comprising:
providing a solid state electrochemical device substrate, the substrate consisting essentially of a material selected from the group consisting of a porous non-noble transition metal, a porous non-noble transition metal alloy, and a porous cement incorporating one or more of a non-noble non-nickel transition metal and a non-noble transition metal alloy;
applying a coating of a suspension of a ceramic material in a liquid medium to the substrate material; and
firing the coated substrate in an inert or reducing atmosphere.

Suitable material for the solid state electrochemical device substrate is a porous cermet composed of 50 vol % Al₂O₃ (e.g., AKP-30) and 50 vol % Inconel 600 with a small amount of binder (e.g., XUS 40303). Suitable material for said coating is yttria stabilized zirconia (YSZ). The abovementioned composite article may be incorporated in solid state electrochemical devices. Said solid state electrochemical devices are said to work in a wide range of operating temperatures, in particular of from about 400° C. to about 1000° C.

International Patent Application WO 2004/106590 in the name of the Applicant, relates to an electrochemical oxygen separator cell including:
a cathode comprising a material selected from lanthanum strontium manganese oxide/doped ceria in a ratio ranging between 85:15 and 75:25 by weight; lanthanum strontium cobalt iron oxide;
an electrolyte membrane comprising ceria doped from 15% to 25% by mole;
an anode comprising a material selected from lanthanum strontium manganese oxide/doped ceria in a ratio ranging between 85:15 and 75:25 by weight; lanthanum strontium cobalt iron oxide.

The abovementioned electrochemical oxygen separator cell is said to yields surprisingly high performances also in the presence of a cell architecture wherein the supporting element is one of the electrode, thus having a thickness greater than that of the electrolyte membrane (for example, a current density of 3 A/cm², at 800° C. and at 0.8 V dc operating voltage, is disclosed).

As known in the art, a measure of electrochemical devices performance may the voltage output from said electrochemical devices for a given current density. Higher performance is associated with a higher voltage output for a given current density or higher current density for a given voltage output. Another measure of electrochemical devices performance may be the Faradaic efficiency, which is the ratio of the actual output current to the total current associated with the consumption of fuel in the electrochemical devices. For various reasons, fuel can be consumed in electrochemical devices without generating an output current, such as when an oxygen bleed is used in the fuel stream (for removing carbon monoxide impurity) or when fuel crosses through a membrane electrolyte and reacts on the cathode instead of the anode. A higher Faradaic efficiency thus represents a more efficient use of fuel.

The Applicant has faced the problem of providing an electrochemical device able to operate in a wide range of operating temperature, in particular at relatively low temperatures (i.e., at temperature of from 600° C. to 800° C.) and having improved performances, in particular in term of current density and/or of Faradaic efficiency.

The Applicant has now found that by using an electrochemical device having a specific cell architecture, a porous supporting electrode with a specific composition as better defined hereinbelow, and a thin electrolyte membrane having a high relative density, it is possible to obtain said improved performances, in particular in term of current density. Moreover, said improved performances are maintained in a wide range of operating temperature, in particular at realtively low temperatures (i.e., at temperature of from 600° C. to 800° C.). Furthermore, an improved Faradaic efficiency is also obtained.

According to a first aspect, the present invention relates to an electrochemical device comprising:
at least one porous supporting electrode comprising at least one electronically conducting material and at least one ionically conducting material, said ionically conducting material having an ionic conductivity, at 800° C., not lower than or equal to 0.005 S/cm⁻¹, preferably of from 0.01 S/cm⁻¹ to 0.1 S/cm⁻¹, said at least one porous supporting electrode having a thickness higher than or equal to 200 μm, preferably of from 500 μm to 2 mm;
at least one electrolyte membrane having a relative density higher than or equal to 90%, preferably of from 95% to 100% and a thickness lower than or equal to 50 μm, preferably of from 5 μm to 30 μm;
at least one porous counter-electrode.

For the purpose of the present description and of the claims which follows the relative density has to be intended as the value obtained as follows: experimental density/theoretical density. Said experimental density may be measured according to techniques known in the art such as, for example, by means of Scanning Electron Microscopy (SEM).

For the purpose of the present description and of the claims which follow, except where otherwise indicated, all numbers expressing amounts, quantities, percentages, and so forth, are to be understood as being modified in all instances by the term “about”. Also, all ranges include any combination of the maximum and minimum points disclosed and include any intermediate ranges therein, which may or may not be specifically enumerated herein.

According to one preferred embodiment, said porous supporting electrode has a porosity higher than or equal to 10%, preferably of from 20% to 50%. Said porosity may be measured according to techniques known in the art such as, for example, by means of Scanning Electron Microscopy (SEM), or of Hg-porosimetry.

According to one preferred embodiment, said electrochemical device may be used as:
a solid oxide fuel cell (SOFC);
an electrochemical oxygen separator cell;
a syn gas generator cell.

According to a more preferred embodiment, said electrochemical device may be used as an electrochemical oxygen separator cell.

According to one preferred embodiment, said porous supporting electrode may be either the anode or the cathode.

According to a further preferred embodiment, in the case said electrochemical device is used as an electrochemical oxygen separator cell, said porous supporting electrode is the anode.

According to a further preferred embodiment, in the case said electrochemical device is used as solid oxide fuel cell (SOFC), said porous supporting electrode is the cathode.

According to one preferred embodiment, said porous supporting electrode comprises:
an amount of from 40% by weight to 90% by weight, preferably of from 50% by weight to 80% by weight, of at least one electronically conducting material, with respect to the total weight of the supporting electrode;
an amount of from 10% by weight to 60% by weight, preferably of from 20% by weight to 50% by weight, of at least one ionically conducting material, with respect to the total weight of the supporting electrode.

According to one preferred embodiment, said electronically conducting material may be selected, for example, from conductive metal alloys including conductive metal oxides such as the rare earth perovskites having the following general formula (I):

A₁₋ₐA′ₐB_{1-b}B′_{b}O_{3-δ} (I)

wherein:
0≦a≦1, 0≦b≦1, and −0.2≦δ≦0.5;
A is at least one rare earth cation such as, for example, La, Pt, Nd, Sm, or Tb;
A′ is at least one dopant cation such as, for example, the alkaline earth cation Sr, or Ca;
B is at least one transition element cation selected from Mn, Co, Fe, Cr, or Ni;
B′ is a transition element cation different from B.

Specific examples of rare earth perovskites having general formula (I) which may be advantageously used according to the present invention are: La₁₋ₐSrₐMnO_{3-δ}(LSM) wherein 0≦a≦0.5; Pr₁₋ₐSrₐMnO_{3-δ}(PSM) wherein 0≦a≦0.6; Pr₁₋ₐSrₐCoO_{3-δ} wherein 0≦a≦0.5; La₁₋ₐSrₐCo_{1-b}Fe_{b}O_{3-δ} (LSCFO) wherein 0≦a≦0.4 and 0≦b≦0.8; La₁₋ₐSrₐCo_{1-b}Ni_{b}O_{3-δ} wherein 0≦a≦0.6 and 0≦b≦0.4; La₁₋ₐSrₐCrO_{3-δ} wherein 0≦a≦0.5; La₁₋ₐCaₐCrO_{3-δ} wherein 0≦a≦0.5.

According to one preferred embodiment, the rare earth perovskites having general formula (I) may be selected, for example, from: La_{0.8}Sr_{0.2}MnO₃ (hereinafter referred to as LSMO-80), La_{0.6}Sr_{0.4}Co_{0.2}Fe_{0.8}O₃ (hereinafter referred to as LSCFO-80), or mixtures thereof. LSCFO-80 is particularly preferred.

According to one preferred embodiment, said ionically conducting material may be selected, for example, from: gadolinium-doped ceria (CGO), samarium-doped ceria (SDC), mixed lanthanum and gallium oxides, or mixtures thereof. Gadolinium-doped ceria (CGO) is particularly preferred. Ce_{0.8}Gd_{0.2}O₁₉₀ (hereinafter referred to as CGO-20) is still particularly preferred.

According to one preferred embodiment, said electrolyte membrane comprises an ionically conducting material having a ionic conductivity, at 800° C., not lower than or equal to 0.005 S/cm⁻¹, preferably of from 0.01 S/cm⁻¹ to 0.1 S/cm⁻¹.

According to a further preferred embodiment, said ionically conducting material may be selected, for example, from: gadolinium-doped ceria (CGO), samarium-doped ceria (SDC), mixed lanthanum and gallium oxides, or mixtures thereof. Gadolinium-doped ceria (CGO) is particularly preferred. Ceo_{0.8}Gd_{0.2}O_{1.90} (hereinafter referred to as CGO-20) is still particularly preferred.

According to one preferred embodiment, said counter-electrode has a porosity higher than or equal to 10%, preferably of from 20% to 50%. Said porosity may be measured by techniques known in the art such as, for example, by means of Scanning Electron Microscopy (SEM), or of Hg-porosimetry.

According to a further preferred embodiment, said counter-electrode has a thickness lower than or equal to 100 μm, preferably of from 10 μm to 50 μm.

The composition of the counter-electrode will be different depending on the use of the electrochemical device.

As already reported above, in the case of said electrochemical device is used as an electrochemical oxygen separator cell, said counter-electrode is the cathode. Said cathode may comprise at least one electronically conducting material and, optionally, at least one ionically conducting material, said ionically conducting material preferably having a ionic conductivity, at 800° C., not lower than or equal to 0.005 S/cm⁻¹, preferably of from 0.01 S/cm⁻¹ to 0.1 S/cm⁻¹. Preferably, said cathode comprises at least one electronically conducting material. Both, said electronically conducting material and said ionically conducting material, may be selected from those above reported.

Examples of counter-electrodes which may be advantageously used in the case of said electrochemical device is used as an electrochemical oxygen separator cell may be found, for example, in International Patent Application WO 2004/106590 above disclosed.

On the contrary, as already reported above, in the case of said electrochemical device is used as solid oxide fuel cell (SOFC), said counter-electrode is the anode. Preferably, said anode comprises nickel (Ni) cermets (ceramic and metallic composite materials) . More preferably, said anode comprises a ceramic material and an alloy comprising nickel and at least a second metal selected from: aluminum, titanium, molybdenum, cobalt, iron, chromium, copper, silicon, tungsten, niobium, said alloy having, preferably an average particle size not higher than 20 nm. The ceramic material of said anode may be selected from gadolinium-doped ceria (GCO), samarium-doped ceria (SDC), mixed lanthanum and gallium oxide.

Examples of counter-electrodes which may be advantageously used the case of said electrochemical device is used as solid oxide fuel cell (SOFC) may be found, for example, in International Patent Application WO 2004/038844 in the name of the Applicant.

As already reported above, the electrochemical device according to the present invention, is able to operate in a wide range of operating temperature, in particular at realtively low temperatures (i.e., at temperature of from 600° C. to 800° C.). In particular, the electrochemical device according to the present invention, provides a current density of 1 A/cm², at 800° C. and at 0.025 V dc operating voltage.

In a further aspect the present invention relates to a process for manufacturing an electrochemical device, said process comprising the following steps:
(a) providing a powder comprising at least one electronically conducting material and at least one ionically conducting material;
(b) placing said powder in a pressing die and apply a pressure, preferably a uniaxial pressure, of from 0.5 MPa to 10 MPa, preferably of from 1 MPa to 5 MPa, at a temperature of from 5° C. to 50° C., preferably of from 8° C. to 30° C., for a time of from 1 minute to 30 minutes, preferably of from 2 minutes to 20 minutes, so as to obtain a green supporting electrode;
(c) applying, by spraying, a homogeneous suspension of at least one jonically conducting material so as to form a thin electrolyte membrane onto said green supporting electrode so as to obtain a green bilayered structure (i.e., green supporting electrode+green electrolyte membrane);
(d) drying the green bilayered structure obtained in step (c), at a temperature of from 70° C. to 120° C., preferably of from 80° C. to 100° C., for a time of from 30 minutes to 8 hours, preferably of from 1 hour to 5 hours;
(e) applying a pressure, preferably a uniaxial pressure, to the dried green bilayered structure obtained in step (d), of from 100 MPa to 500 MPa, preferably of from 150 MPa to 300 MPa, at a temperature of from 5° C. to 50° C., preferably of from 8° C. to 30° C., for a time of from 5 minute to 1 hour, preferably of from 10 minutes to 30 minutes;
(f) remove the pressed green bilayered structure obtained in step (e) from the pressing die and sintering said green bilayered structure at a temperature of from 800° C. to 1300° C., preferably of from 900° C. to 1200° C., so as to obtain a sintered bilayered structure (i.e., sintered supporting electrode +sintered electrolyte membrane);
(g) applying a counter-electrode onto the sintered bilayered structure obtained in step (f) so as to obtain a trilayered structure (i.e., sintered supporting electrode+sintered electrolyte membrane+green counter-electrode);
(h) sintering the trilayered structure obtained in step (g) at a temperature of from 800° C. to 1200° C., preferably of from 900° C. to 1100° C., so as to obtain an electrochemical device.

Preferably, said step (d) is carried out by means of infrared rays.

The terms “green supporting electrode”, “green bilayered structure” (i.e., green supporting electrode+green elecrolyte membrane),. “green counter-electrode”, indicate that the materials from which they are made have not yet been fired to a temperature sufficiently high to sinter said materials. As it is known in the art, sintering refers to a process of forming a coherent mass, for example from a metallic powder, by heating without melting.

The powder comprising at least one electronically conducting material and at least one ionically conducting material of step (a) may be made by processes known in the art. For example, said powder may be made by a process comprising the following steps:
(a₁) milling, preferably in a ball mill, a mixture of at least one electronically conducting material in powder form, at least one ionically conducting material in powder form, and at least one pore-former such as, for example, carbon, polymers, starches, optionally in the presence of a binding agent such as, for example, polyvinyl alcohol, polyvinyl butiral, polymethyl methacrylate, ethyl cellulose, said binding agent being preferably dissolved in water, at a temperature of from 15° C. to 100° C., preferably of from 20° C. to 70° C., for a time of from 30 minutes to 2 hours, preferably of from 40 minutes to 1.5 hours, so as to obtain a slurry;
(a₂) drying the slurry obtained in step (a₁), at a temperature of from 70° C. to 120° C., preferably of from 80° C. to 100° C., for a time of from 30 minutes to 8 hours, preferably of from 1 hours to 5 hours, said step being preferably carried out by means of infrared rays;
(a₃) adding an organic solvent such as, for example, methanol, ethanol, isopropanol, to the dried slurry obtained in step (a₂) and milling, preferably in a ball mill, said slurry at a temperature of from 10° C. to 50° C., preferably of from 20° C. to 35° C., for a time of from 5 hours to 24 hours, preferably of from 10 hour to 20 hours;
(a₄) drying the slurry obtained in step (a₃), at a temperature of from 70° C. to 120° C., preferably of from 80° C. to 100° C., for a time of from 30 minutes to 8 hours, preferably of from 1 hours to 5 hours, said step being preferably carried out by means of infrared rays;
(a₅) grinding the slurry obtained in step (a₄), said step being preferably carried out in a agata mortar, so as to obtain a powder comprising at least one electronically conducting material and at least one ionically conducting material.

The homogeneous suspension of at least one lonically conducting material of step (c) of the above disclosed process, may be made by processes known in the art. For example, said homogeneous suspension of at least one ionically conducting material may be made by:
(c₁) milling, preferably in a ball mill, at least one ionically conducting material in powder form and at least one organic solvent such as, for example, methanol, ethanol, isopropanol, at a temperature of from 10° C. to 50° C., preferably of from 20° C. to 35° C., for a time of from 5 hours to 24 hours, preferably of from 10 hour to 20 hours, so as to obtain a slurry;
(c₂) drying the slurry obtained in step (c₁), at a temperature of from 70° C. to 120° C., preferably of from 80° C. to 100° C., for a time of from 30 minutes to 8 hours, preferably of from 1 hours to 5 hours, said step being preferably carried out by means of infrared rays;
(c₃) placing the dried slurry obtained in step (c₂) in a ultrasonic bath, for a time of from 5 minutes to 1 hours, preferably of from 10 minutes to 30 minutes, so as to obtain a homogeneous suspension.

The counter-electrode of step (g) may be made according to processes known in the art. For example, said counter-electrode may be made by means of the process disclosed in International Patent Applications WO 2004/038844, or WO 2004/106590 above disclosed. Alternatively, said counter-electrode may be made according to the process for making a porous supporting electrode disclosed above.

The step (g) of the process above reported may be carried out according to techniques known in the art such as, for example, by spraying. Further details regarding said techniques may be found, for example, in International Patent Applications WO 2004/038844, or WO 2004/106590 above disclosed.

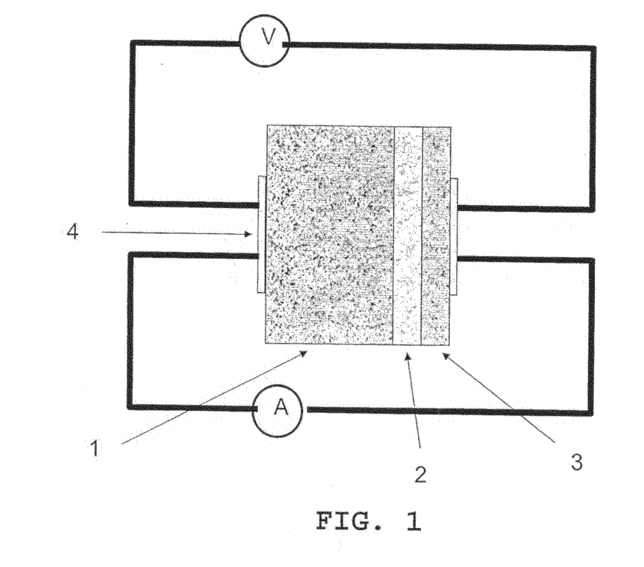

The present invention will now be illustrated in further detail by means of the attached FIG. 1-5, wherein:

FIG. 1 shows a schematic view of an electrochemical oxygen separator cell according to the present invention;

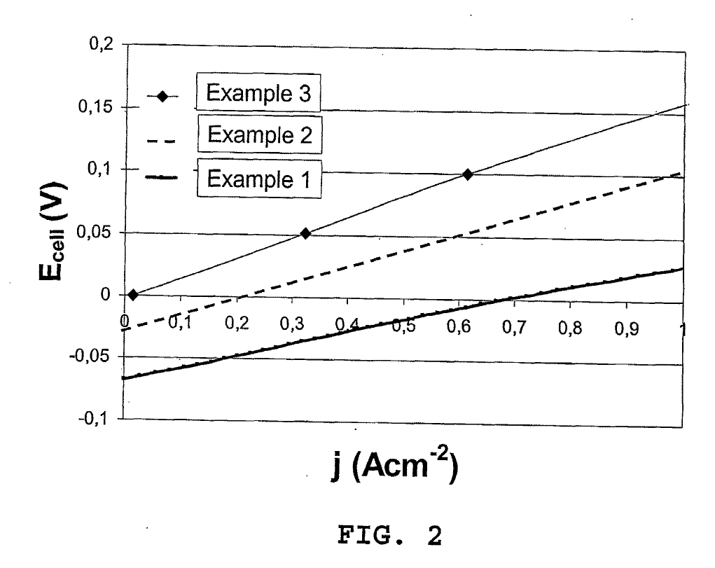

FIG. 2 shows the polarization measurement of the electrochemical oxygen separator cells according to Example 1-3;

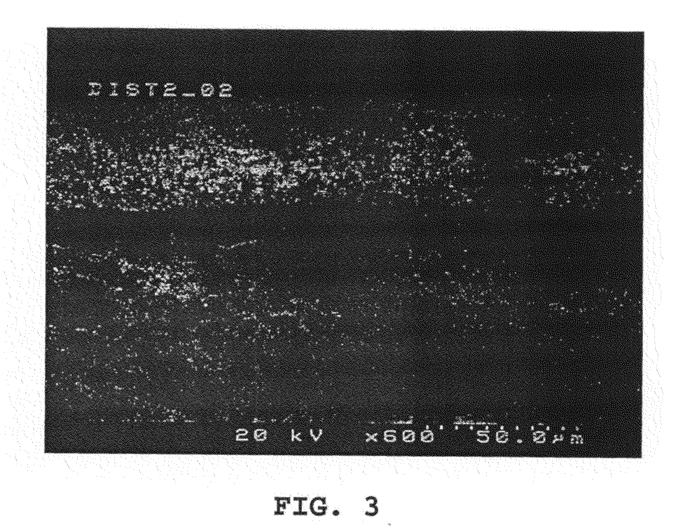

FIG. 3-5 show a Scanning Electron Microscopy (SEM) view of the trilayered structure [anode (supporting electrode)+electrolite membrane+cathode (counter-electrode) ] according to Examples 1-3.

FIG. 1 shows an electrochemical oxygen separator cell comprising an anode (1), an electrolyte membrane (2), a cathode (3), and metal contacts (4) for the connection to the electric circuit.

The present invention will be further illustrated below by means of a number of preparation examples, which are given for purely indicative purposes and without any limitation of this invention.

### EXAMPLE 1

An electrochemical oxygen separator cell having the following architecture and composition was prepared and tested.

### Anode

| | |
|---|---|
| Composition: | 30% wt of CGO-20 + 70% wt of LSCFO-80; |
| Thickness: | 500 μm. |

### Electrolyte Membrane

| | |
|---|---|
| Composition: | CGO-20 |
| Thickness: | 12 μm. |

### Cathode

| | |
|---|---|
| Composition: | LSCFO-80; |
| Thickness: | 30 μm. |

### Anode Preparation

Ball milling, for 1 hour, at room temperature (23° C.), 3.0 g of CGO-20 (primary particle size of 28 nm, BET surface area of 7.84 m²/g; from Praxair), 7 g of LSCFO-80 (primary particle size of 9 nm, BET surface area of 4.12 m²/g; from Praxair), 1 g of polyvinyl alcohol (molecular weight range: 13000-23000) previously dissolved in 20 ml water at 60° C. as a binding agent and 1 g of carbon (Timrex KS4, BET surface area of 25 m²/g; from Timcal) as a pore-former. The obtained slurry was dried at 90° C., by infrared rays, for 3 hours. 30 ml of ethanol was then added to the dried slurry which was subsequently ball milled, for 14 hours, at room temperature (23° C.), and then was dried at 90° C., by infrared rays, for 3 hours. Then, the dried slurry was grinded in a agata mortar obtaining a powder. The obtained powder was subsequently placed in a pressing die having a cylindrical shape (φ=16 mm, d=1 mm) and was subjected to a uniaxial pressure of 2 MPa, at a temperature of 10° C., for 5 min, obtaining a green supporting anode.

### Electrolyte Membrane Preparation

CGO-20 powder (10 g) was mixed with ethanol (20 ml) in a ball mill, at room temperature (23° C.), for 14 hours, to give a slurry. Said slurry was dried at 90° C., by infrared rays, for 3 hours and was subsequently placed in an ultrasonic bath, for 15 minutes obtaining a homogeneous suspension. The resulting suspension was sprayed by an aerograph device onto the green supporting anode obtained as disclosed above, operating at the following conditions:
temperature: room temperature (23° C.);
pressure: 2 bar;
spray-on: 2 seconds; then spray-off: 3 seconds;
total time of spray-on: 60 seconds.

A green bilayered structure (green supporting anode+green electrolyte membrane) was obtained which was subsequently dried at 90° C., by infrared rays, for 3 hours and was then subjected to an uniaxial pressure of 200 MPa, at room temperature (23° C.), for 20 min.

Subsequently, the green bilayered structure was removed from the pressing die and was fired, to burn out the pore-former and the binding agent and to sinter the structure, according to the following conditions: heating at 1° C./min to 350° C., held 2 hours, heating at 1° C./min to 1150° C., held 6 hours, cooling at 2° C./min to 25° C.: a sintered bilayered structure (sintered supporting anode+sintered electrolyte membrane) was obtained.

### Cathode Preparation

CGO-20 powder (10 g) was mixed with ethanol (20 ml) in a ball mill, at room temperature (23° C.), for 14 hours to give a slurry. Said slurry was dried at 90° C., by infrared rays, for 3 hours and subsequently placed in an ultrasonic bath, for 15 minutes obtaining a homogeneous suspension. The resulting suspension was sprayed by an aerograph device onto the sintered bilayered structure obtained as above disclosed, operating at the following conditions:
temperature: room temperature (23° C.);
pressure: 2 bar;
spray-on: 2 seconds; then spray-off: 3 seconds;
total time of spray-on: 60 seconds.

A trilayered structure (sintered supporting anode+sintered electrolyte membrane+green cathode) was sintered operating at the following conditions: heating at 15° C./min to 950° C., held 2 hours, cooling at 5° C./min to room temperature (23° C.) obtaining the desired electrochemical oxygen separator cell.

The characteristics of the electrochemical oxygen separator cell obtained as disclosed above, were the following:
supporting anode: ≧30% porosity (measured by Hg-porosimetry);
electrolyte membrane: ≧95% relative density [measured by Scanning Electron Microscopy (SEM)];
cathode: ≧30% porosity [measured by Scanning Electron Microscopy (SEM)]. FIG. 3 shows a Scanning Electron Microscopy (SEM) view of the electrochemical oxygen separator cell (i.e., starting from the bottom of the SEM view, supporting anode+electrolyte membrane+cathode) obtained as disclosed above, in cross-section. SEM view shows a porous anode (supporting electrode), a porous cathode (counter-electrode) and a dense electrolyte membrane according to the present invention.

### Polarization Measurement

The polarization measurement was carried out by potentiometric measurement [by applying a voltage (V) and measuring the current density (A/cm²)] by means of an electrochemical oxygen separator cell according to the schematic drawing of FIG. 1.

The measurement was carried out by an AUTOLAB Ecochemie potentiostat/galvanostat and impedance analyzer, at 800° C., by fluxing He (20 cc/min) at the anode side and maintaining static air at the cathode side. The results are set forth in FIG. 2. A current density of 1.0 A/cm² was observed at 0.025 V operating voltage.

Moreover, a Faradaic Efficiency was measured. To this aim, the expected flux of oxygen produced by an electrochemical oxygen separator cell according to the schematic drawing of FIG. 1 was calculated according to the Faraday law:

$$mols {O}_{2} = \frac{I \times t}{4 \times F}$$

wherein I is the electrical current (A), t is time (sec), F is the Faraday constant (i.e. 96485.3 C/eq) and 4 is the number of electrons exchanged in the electrochemical reaction: 20⁻²→4e⁻+O₂, eq/mol.

On the other end, the real flux of oxygen produced by said electrochemical oxygen separator cell was measured, at the anode side, by fluxing He (20 cc/min) and by recovering the oxygen produced which was further analyzed by a gas cromatography. The Faradaic efficiency was of 98±2%.

### EXAMPLE 2 (COMPARATIVE)

An electrochemical oxygen separator cell having the architecture and composition as disclosed in Example 1 was prepared and tested, the only difference being in the anode preparation: the pore-former was not used.

The characteristics of the electrochemical oxygen separator cell obtained as disclosed above, were the following:
supporting anode: ≦15% porosity (measured by Hg-porosimetry);
electrolyte membrane: ≧95% relative density [measured by Scanning Electron Microscopy (SEM)];
cathode: ≧30% porosity [measured by Scanning Electron Microscopy (SEM)].

The polarization measurement and the Faradaic efficiency measurement was carried out as described in Example 1.

The results of polarization measurement are set forth in FIG. 2. A current density of 1.0 A/cm² was observed at 0.10 V operating voltage.

The Faradaic efficiency was of 98±2%.

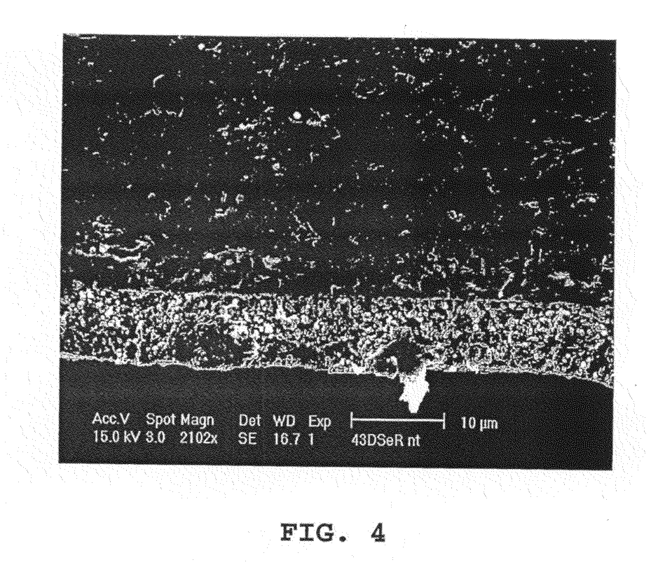

FIG. 4 shows a scanning electron microscope (SEM) view of the electrochemical oxygen separator cell [i.e, starting from the top of the SEM view, supporting anode+electrolyte membrane+cathode) obtained as disclosed above, in cross-section. SEM view shows a dense anode (supporting electrode), a dense electrolyte membrane dense, and a porous cathode (counter-electrode). GIUSTO???

### EXAMPLE 3 (COMPARATIVE)

An electrochemical oxygen separator cell having the architecture and composition as disclosed in Example 1 was prepared and tested. The differences in the preparation were the following:
in the anode preparation the pore former was not used; and
the obtained green bilayered structure, after having been dried at 90° C., by infrared rays, for 3 hours, was not subjected to a uniaxial pressure of 200 MPa, for 20 min.

The characteristics of the electrochemical oxygen separator cell obtained as disclosed above, were the following:
supporting anode: ≦15% porosity (measured by Hg-porosimetry);
electrolyte membrane: ≦60% relative density [measured by Scanning Electron Microscopy (SEM)];
cathode: ≧30% porosity [measured by Scanning Electron Microscopy (SEM)].

The polarization measurement and the Faradaic efficiency measurement was carried out as described in Example 1.

The results of polarization measurement are set forth in FIG. 2. A current density of 1.0 A/cm² was observed at 0.16 V operating voltage.

The Faradaic efficiency was of 45±2%.

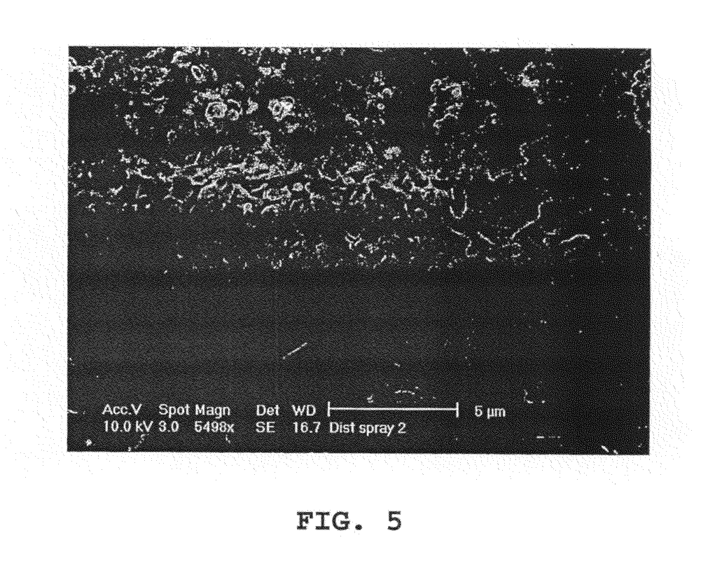

FIG. 5 shows a scanning electron microscope (SEM) view of the electrochemical oxygen separator cell [i.e, starting from the bottom of the SEM view, supporting anode+electrolite membrane+cathode) obtained as disclosed above, in cross-section. SEM view shows a dense anode (supporting electrode), a porous electrolyte membrane and a porous cathode (counter-electrode).

1-39. (canceled)

40. An electrochemical device comprising:
at least one porous supporting electrode comprising at least one electronically conducting material and at least one ionically conducting material, said ionically conducting material having an ionic conductivity, at 800° C., not lower than or equal to 0.005 S/cm⁻¹, and said at least one porous supporting electrode having a thickness higher than or equal to 200 μm;
at least one electrolyte membrane having a relative density higher than or equal to 90% and a thickness lower than or equal to 50 μm; and
at least one porous counter-electrode.

41. The electrochemical device according to claim 40, wherein said at least one ionically conducting material has a ionic conductivity, at 800° C., of 0.01 S/cm⁻¹ to 0.1 S/cm⁻¹.

42. The electrochemical device according to claim 40, wherein said at least one porous supporting electrode has a thickness of 500 μm to 2 mm.

43. The electrochemical device according to claim 40, wherein said at least one electrolye membrane has a relative density of 95% to 100%

44. The electrochemical device according to claim 40, wherein said at least one electrolyte membrane has a thickness of 5 μm to 30 μm.

45. The electrochemical device according to claim 40 wherein said porous supporting electrode has a porosity higher than or equal to 10%.

46. The electrochemical device according to claim 45, wherein said porous supporting electrode has a porosity of 20% to 50%.

47. The electrochemical device according to claim 40, wherein said electrochemical device is a solid oxide fuel cell.

48. The electrochemical device according to claim 40, wherein said electrochemical device is an electrochemical oxygen separator cell.

49. The electrochemical device according to claim 40, wherein said electrochemical device is a syn gas generator cell.

50. The electrochemical device according to claim 40, wherein said porous supporting electrode is either an anode or a cathode.

51. The electrochemical device according to claim 50, wherein said electrochemical device is an electrochemical oxygen separator cell and said porous supporting electrode is the anode.

52. The electrochemical device according to claim 50, wherein said electrochemical device is a solid oxide fuel cell and said porous supporting electrode is the cathode.

53. The electrochemical device according to claim 40, wherein said porous supporting electrode comprises:
40% by weight to 90% by weight of at least one electronically conducting material with respect to the total weight of the supporting electrode; and
10% by weight to 60% by weight of at least one ionically conducting material with respect to the total weight of the supporting electrode.

54. The electrochemical device according to claim 53, wherein said porous supporting electrode comprises:
50% by weight to 80% by weight of at least one electronically conducting material with respect to the total weight of the supporting electrode; and
20% by weight to 50% by weight of at least one ionically conducting material with respect to the total weight of the supporting electrode.

55. The electrochemical device according to claim 40, wherein said electronically conducting material is selected from conductive metal alloys comprising conductive metal oxides, rare earth perovskites having the following general formula (I):
A₁₋ₐA′ₐB_{1-b}B′_{b}O_{3-δ} (I)
wherein:
0≦a≦1, 0≦b≦1, and −0.2≦δ≦0.5;
A is at least one rare earth cation, an La ion, a Pt ion, an Nd ion, an Sm ion, or a Tb ion;
A′ is at least one dopant cation, an alkaline earth cation Sr, or an alkaline earth cation Ca;
B is at least one transition element cation selected from Mn, Co, Fe, Cr, or Ni; and
B′ is a transition element cation different from B.

56. The electrochemical device according to claim 55, wherein said electronically conducting material is selected from: La₁₋ₐSrₐMnO_{3-δ}, wherein 0≦a≦0.5; Pr₁₋ₐSrₐMnO_{3-δ}, wherein 0≦a≦0.6; Pr₁₋ₐSrₐCoO_{3-δ}, wherein 0≦a≦0.5; La₁₋ₐSrₐCo_{1-b}Fe_{b}O_{3-δ}, wherein 0≦a≦0.4 and 0≦b≦0.8; La₁₋ₐSrₐCo_{1-b}Ni_{b}O_{3-δ}, wherein 0≦a≦0.6 and 0≦b≦0.4; La₁₋ₐSrₐCrO_{3-δ}, wherein 0≦a≦0.5; La₁₋ₐCaₐCrO_{3-δ} wherein 0≦a≦0.5.

57. The electrochemical device according to claim 56, wherein said electronically conducting material is selected from: La_{0.8}Sr_{0.2}MnO₃, La_{0.6}Sr_{0.4}Co_{0.2}Fe_{0.8}O₃, or mixtures thereof.

58. The electrochemical device according to claim 40, wherein said ionically conducting material is selected from: gadolinium-doped ceria, samarium-doped ceria, mixed lanthanum and gallium oxides, or mixtures thereof.

59. The electrochemical device according to claim 58, wherein said tonically conducting material is gadolinium-doped ceria.

60. The electrochemical device according to claim 40, wherein said electrolyte membrane comprises an ionically conducting material having an ionic conductivity, at 800° C., not lower than or equal to 0.005 S/cm⁻¹.

61. The electrochemical device according to claim 60, wherein said electrolyte membrane comprises an ionically conducting material having an ionic conductivity, at 800° C., of 0.01 S/cm⁻¹ to 0.1 S/cm⁻¹.

62. The electrochemical device according to claim 60, wherein said ionically conducting material is selected from: gadolinium-doped ceria, samarium-doped ceria, mixed lanthanum oxide and gallium oxide, or mixtures thereof.

63. The electrochemical device according to claim 62, wherein said ionically conducting material is gadolinium-doped ceria.

64. The electrochemical device according to claim 40, wherein said counter-electrode has a porosity higher than or equal to 10%.

65. The electrochemical device according to claim 64, wherein said counter-electrode has a porosity of 20% to 50%.

66. The electrochemical device according to claim 40, wherein said counter-electrode has a thickness lower than or equal to 100 82 m.

67. The electrochemical device according to claim 66, wherein said counter-electrode has a thickness of 10 μm to 50 μm.

68. A process for manufacturing an electrochemical device comprising the following steps:
(a) providing a powder comprising at least one electronically conducting material and at least one ionically conducting material;
(b) placing said powder in a pressing die and applying a pressure of 0.5 MPa to 10 MPa, at a temperature of 5° C. to 50° C., for 1 minute to 30 minutes;
(c) applying, by spraying, a homogeneous suspension of at least one ionically conducting material so as to form a thin electrolyte membrane onto a green supporting electrode, so as to obtain a green bilayered structure;
(d) drying the green bilayered structure obtained in step (c), at a temperature of 70° C. to 120° C., for 30 minutes to 8 hours;
(e) applying a pressure to the dried green bilayered structure obtained in step (d), of 100 MPa to 500 MPa, at a temperature of 5° C. to 50° C., for 5 minute to 1 hour;
(f) removing the pressed green bilayered structure obtained in step (e) from the pressing die and sintering said green bilayered structure at a temperature of 800° C. to 1200° C., so as to obtain a sintered bilayered structure;
(g) applying a counter-electrode onto the sintered bilayered structure obtained in step (f) so as to obtain a trilayered structure; and
(h) sintering the trilayered structure obtained in step (g) at a temperature of 800° C. to 1200° C., so as to obtain an electrochemical device.

69. The process according to claim 68, wherein step (b) is carried out by applying a pressure of 1 MPa to 5 MPa.

70. The process according to claim 68, wherein step (b) is carried out at a temperature of 8° C. to 30° C.

71. The process according to claim 68, wherein step (b) is carried out for 2 minutes to 20 minutes.

72. The process according to claim 68, wherein step (d) is carried out at a temperature of 80° C. to 100° C.

73. The process according to claim 68, wherein step (d) is carried out for 1 hour to 5 hours.

74. The process according to claim 68, wherein step (e) is carried out by applying a pressure of 150 MPa to 300 MPa.

75. The process according to claim 68, wherein step (e) is carried out at a temperature of 8° C. to 30° C.

76. The process according to claim 68, wherein step (e) is carried out for 10 minutes to 30 minutes.

77. The process according to claim 68, wherein step (f) is carried out at a temperature of 900° C. to 1200° C.

78. The process according to claim 68, wherein step (h) is carried out at a temperature of 900° C. to 1100° C.
